(19) United States
(12) Patent Application Publication
(10) Pub. No.: US 2010/0006656 A1
(43) Pub. Date: Jan. 14, 2010

(54) Magnetically Addressable Bistable Film

(75) Inventor: Nabil M. Lawandy, Saunderstown, RI (US)

Correspondence Address: K&L Gates LLP, STATE STREET FINANCIAL CENTER, One Lincoln Street, BOSTON, MA, 02111-2950, US

(73) Assignee: SPECTRA SYSTEMS CORPORATION, Providence, RI (US)

(21) Appl. No.: 12/501,184

(22) Filed: Jul. 10, 2009

Related U.S. Application Data
(60) Provisional application No. 61/134,595, filed on Jul. 11, 2008.

(51) Int. Cl. G06K 19/06; B32B 3/10

(52) U.S. Cl. 235/493; 428/321.5

(57) ABSTRACT

A magnetically addressable bistable film includes a polymeric substrate impregnated with polymeric microcapsules that contain liquid-suspended magnetically orientable or magnetophoretic material. The material is subject to reorientation either in the plane or perpendicular to the plane of the film, as well to forces of attraction, due to an external magnetic field. The two states provide sufficient difference in light reflectivity to create visible contrast by addressing the film locally, either on a pixel-by-pixel basis or by spatially patterning the driving magnetic field itself. The congregation of magnetophoretic materials in one portion of the microcapsule may also provide sufficient difference in light reflectivity to create visible contrast.

### CROSS-REFERENCE TO RELATED APPLICATION

This application claims the benefit of U.S. Provisional Patent Application No. 61/134,595, filed Jul. 11, 2008, the entire disclosure of which is incorporated by reference herein.

### FIELD OF INVENTION

The invention relates generally to films, and more specifically to magnetically addressable bistable films.

### BACKGROUND

The United States Postal Service (“USPS”) specifies several types of containers to be utilized in mail sorting and delivery chains. Among the containers utilized are trays used for automated rate mailings for periodicals and standard mail, such as letter size and flat mail pieces, in different levels of presorting. According to the Domestic Mail Manual (“DMM”), the trays utilized must measure approximately 21″ long, 10″ wide and 4⅝″ high (DMM 345.3.2).

Each mail tray must bear a tray-size 2″ label that meets applicable physical and barcode standards, such as being capable of machine printing. Currently, these labels are single-use paper labels that are inserted into label-holders for each delivery. One of the tray standards requires the label to be inserted completely into a label holder to prevent its loss during transport and processing. Inserting paper labels manually into label-holders affixed to the front of the trays creates several opportunities for errors to occur. The label itself may become damaged or unreadable when inserted, or labels may fall out of the holders. Insertion of the labels, whether by human or automated means, leaves the possibility of damage to the label and incorrect or mismatched labels. When using barcodes, the slightest defect introduced to the label may prevent accurate reading, scanning or processing of the tray by the automation equipment.

Further, printing of insertable labels for the rigid standards of the USPS using sophisticated printers, ink, and paper can be time-consuming, expensive and environmentally damaging. Many of these labels cannot be reused and must be discarded, requiring new labels to be printed.

Generally, any industry that requires labeling and re-labeling of containers, such as shipping or warehouse companies, faces similar problems to the USPS. Paper, ink, and other printing supplies are expensive and can be harmful to the environment. Thus, there is a need for an addressable medium for use in labeling containers that is rewritable, durable, cost effective and environmentally sound.

### SUMMARY OF THE INVENTION

Embodiments of the invention include a magnetically addressable bistable film. According to one embodiment, the film is a polymeric substrate impregnated with polymeric microcapsules that contain liquid-suspended magnetically orientable or magnetophoretically active material, such as ferromagnetic platelets or particles. The platelets or particles are subject to reorientation either in the plane or perpendicular to the plane of the film, as well to body forces of attraction or repulsion from high field regions (depending on the type of magnetic material), in an applied external magnetic field. The two states of orientation or the accumulation of particles on one side of the microcapsule provide sufficient difference in light reflectivity to create visible contrast by addressing the film locally, either on a pixel-by-pixel basis or by spatially patterning the driving magnetic field itself. Further, the proper removal of the field results in a stable state in which the film maintains its reflectivity. Replacing paper labels with multiple-use rewritable labels has a potential in reducing costs and significantly improving the environmental impact of the process.

According to one embodiment of the invention, a magnetically addressable film includes a substrate and a plurality of microcapsules disposed in the substrate. Each of the microcapsules includes a liquid and a magnetically orientable material suspended in the liquid. The application of a magnetic field is capable of aligning the magnetically orientable material into an alignment.

According to another embodiment, a re-addressable label includes a substrate and a plurality of microcapsules disposed in the substrate. Each of the microcapsules includes a liquid and a magnetically orientable or magnetophoretic material suspended in the liquid. A first application of a magnetic field to the label is capable of aligning the magnetically orientable material into an alignment or dragging the particles to one side of the capsule, and a second application of a magnetic field to the label is capable of altering the alignment or shifting the accumulation of particles on the one side of the microcapsule.

In yet another embodiment, a re-addressable label includes a receptacle, a substrate affixed to the receptacle, and a plurality of microcapsules disposed in the substrate. The microcapsules include a liquid and a magnetically orientable material suspended in the liquid. A first application of a magnetic field to the substrate is capable of aligning the magnetically orientable material into an alignment or accumulating the particles on one side of the capsule through magnetophoretic motion.

Another embodiment of the invention includes a method for addressing a bistable film by providing a substrate having a plurality of microcapsules disposed in the substrate. Each of the microcapsules includes a liquid and a magnetically orientable or magnetophoretic material suspended in the liquid. A magnetic field is applied to the film to align the magnetically orientable material into an alignment.

According to one embodiment of the invention, a magnetically addressable film includes a substrate and a plurality of microcapsules disposed in the substrate. Each of the microcapsules includes a liquid and a magnetophoretic material suspended in the liquid. The application of a magnetic field is capable of dragging the magnetophoretic material into a congregation near a side portion of at least some of the microcapsules.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a depiction of a magnetically sensitive film in accordance with an embodiment of the invention;

FIG. 2A-B depict cross-sectional views of a microcapsule in accordance with an embodiment of the invention; and

FIG. 3 is an illustrative example of an addressed magnetic file in accordance with an embodiment of the invention.

### DETAILED DESCRIPTION

The invention will be more completely understood through the following detailed description, which should be read in conjunction with the attached drawings. Detailed embodiments of the invention are disclosed herein; however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art variously to employ the invention in virtually any appropriately detailed embodiment.

In one embodiment, a bistable magnetic film includes a substrate, which may be a polymer, impregnated with polymeric microcapsules that contain liquid-suspended magnetically orientable material, such as ferromagnetic platelets. The platelets, which may be planar, are subject to reorientation either in the plane or perpendicular to the plane of the film, as well as to attractive forces dragging them, by an external magnetic field. The two states of orientation provide sufficient difference in light reflectivity to create visible contrast when a light source addresses the film locally, either on a pixel-by-pixel basis or by spatially patterning the driving magnetic field itself. In particular, the unoriented platelets in a microcapsule may only allow a limited amount of light to pass through the microcapsule, but the oriented platelets may allow light to pass through the microcapsule unobstructed or may further prevent light from passing through the microcapsule if the platelets are all dragged to and congregated at either the top or bottom of the microcapsule. Differences in illuminated microcapsules in different regions of the substrate create visibly recognizable patterns or characters. Alternatively, the microcapsules may include magnetophoretic particles suspended in liquid, whereby the application of a magnetic field causes the accumulation of the magnetophoretic particles in one portion of the microcapsule, i.e., a left, right, top or bottom portion of the microcapsule.

One embodiment of the invention includes a label that is reusable and rewritable. When the label is written using the application of a magnetic field, the label retains the written image over an extended period of time under reasonable ambient conditions, without significant changes to temperature, moisture, wind, or other environmental factors, and without any supply of power. The rewriting of the label is external (i.e., with the use of a stylus or other magnetic implementation); however contact of the writing apparatus with the label is permitted for periods of the order of 5 seconds, without reversing the effects of the applied field.

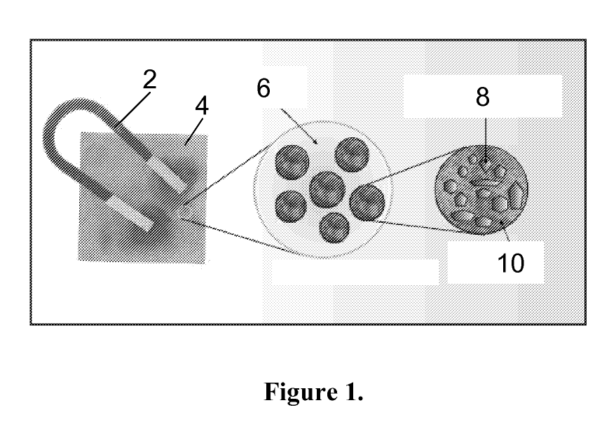

As shown in FIG. 1, one embodiment of the invention includes a polymeric film 4 having several polymeric microcapsules 6 embedded therein. The film 4 may be a polyester film such as biaxially-oriented polyethylene terephthalate or Mylar. The microcapsules 6 are filled with a colored oil 10 or other indicative material and suspended magnetically orientable material 8, such as ferromagnetic or Nickel flakes or platelets. In one embodiment, the platelets 8 are aligned in either a planar orientation or a perpendicular orientation (i.e., perpendicular to the plane of the film). The polymeric microcapsules 6 may be made of copolymers of differing weights and may be made of materials such as pigskin gelatin, gum Arabic, or ethylenemaleic anhydride.

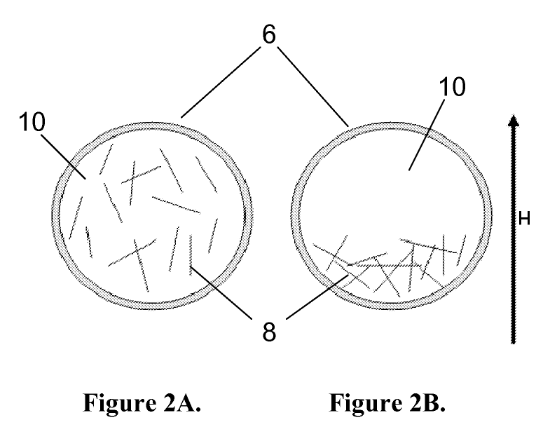

According to one embodiment, the magnetic or magnetophoretic flakes or platelets 8 within the microcapsules 6 are dragged to top, bottom, or one side of the microcapsule 6 by the application of a magnetic field to provide a distinctive reflective pattern that can be arranged, with other similarly magnetized microcapsules, to create identifiable or machine-readable patterns such as numbers, letters, or barcodes. As depicted in FIG. 2A, a microcapsule 6 contains a plurality of magnetic or magnetophoretic flakes 8 suspended in a liquid 10. In the absence of a magnetic field, the flakes 8 float in a random arrangement within the microcapsule 6. When a magnetic field (H) is applied, as shown in FIG. 2B, the flakes are dragged to the bottom portion of the microcapsule 6 to a concentrated arrangement. The magnetic material 8 in the concentrated arrangement remains in a random alignment; however, the opacity of the microcapsule is altered, thereby forming a detectable concentration of the particles.

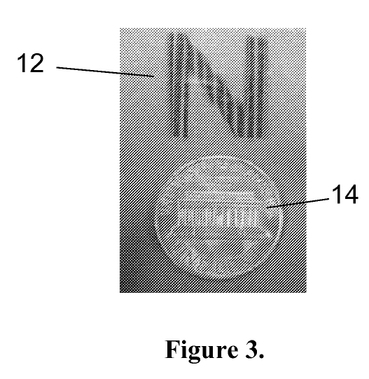

Another illustrative example of one embodiment of the invention is depicted in FIG. 3. The letter “N” 12 has been created by aligning the ferromagnetic platelets in the microcapsules of the film by applying an external magnetic field, e.g., using a stylus. In the illustrative embodiment, the resulting character is roughly the size of a United States penny 14. Re-disturbing the magnetic field by an external source, such as a magnet having a different polarity, alters the alignment of the platelets and provides a different reflection pattern from the previous writing, either erasing the pattern or creating a new pattern. Such a configuration allows the film to be re-written and re-used without the burdensome effort of removing the label, printing a new label according to rigid standards, and carefully inserting the label manually into the label holder. Further, the detectable pattern will retain its alignment and orientation to the plane of the film without any external power source, allowing the pattern displayed in the film to persist over time.

According to one embodiment, the bistable film is affixed to the front of a sorting tray in a mail sorting operation, such as operations by the USPS. Upon a determination of the contents of the label, a magnetic field is applied to the film, either by a magnetic stylus, electromagnetic manipulation or other magnetic influence to “write” the contents of the label. The contents of the label may be a series of numbers and letters, such as a code or set of instructions, or a machine-readable barcode suitable for an automated scanning process. After the tray is processed, transported, or disposed of otherwise, the label may be wiped by a magnetic stimulus or simply re-written to reflect a new label.

Applications of the embodiments of the invention, while described herein as a tool for the USPS, may be implemented in any suitable environment in which containers are labeled and re-labeled. Example industries may include, without limitation, warehouses and shipping companies that must label containers, retail stores and markets that label shelving or storage containers, offices and administrative services that label files, cabinets, boxes, etc., and even consumers prone to label and re-label containers in the home.

While embodiments of the invention described herein include magnetically orientable flakes or platelets or magnetophoretic particles, one skilled in the art should recognize that other magnetic materials and shapes (e.g., particles, beads, pellets, nanoparticles, etc.) may be used without deviating from the scope of the invention.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A magnetically addressable film comprising:
a substrate; and
a plurality of microcapsules disposed in the substrate, each of the microcapsules comprising a liquid and a magnetically orientable material suspended in the liquid;
wherein application of a magnetic field is capable of aligning the magnetically orientable material into an alignment.

2. The magnetically addressable film of claim 1 wherein the alignment is stable.

3. The magnetically addressable film of claim 1 wherein the application of the magnetic field aligns the magnetically orientable material near an upper portion of at least some of the plurality of microcapsules.

4. The magnetically addressable film of claim 1 wherein the application of the magnetic field aligns the magnetically orientable material near a bottom portion of at least some of the plurality of microcapsules.

5. The magnetically addressable film of claim 1 wherein the substrate comprises a polymer.

6. The magnetically addressable film of claim 5 wherein the polymer is a polyester.

7. The magnetically addressable film of claim 6 wherein the substrate comprises biaxially-oriented polyethylene terephthalate.

8. The magnetically addressable film of claim 1 wherein the liquid has a color.

9. The magnetically addressable film of claim 1 wherein each of the microcapsules comprises a shell.

10. The magnetically addressable film of claim 9 wherein the shell comprises a copolymer.

11. The magnetically addressable film of claim 10 wherein the plurality of microcapsules comprise shells of copolymers having different weights.

12. The magnetically addressable film of claim 11 wherein the copolymers are selected from the group consisting of pigskin gelatin, gum Arabic, and ethylenemaleic anhydride.

13. The magnetically addressable film of claim 1 wherein the magnetically orientable material comprises ferromagnetic platelets.

14. The magnetically addressable film of claim 1 wherein the alignment comprises a machine-readable pattern.

15. The magnetically addressable film of claim 14 wherein the machine-readable code comprises a bar code.

16. The magnetically addressable film of claim 1 wherein the alignment comprises an alpha-numeric character.

17. A re-addressable label comprising:
a substrate; and
a plurality of microcapsules disposed in the substrate, each of the microcapsules comprising a liquid and a magnetically orientable material suspended in the liquid;
wherein a first application of a magnetic field to the label is capable of aligning the magnetically orientable material into an alignment; and
wherein a second application of a magnetic field to the label is capable of altering the alignment.

18. A re-addressable label comprising:
a receptacle;
a substrate affixed to the receptacle; and
a plurality of microcapsules disposed in the substrate, each of the microcapsules comprising a liquid and a magnetically orientable material suspended in the liquid;
wherein a first application of a magnetic field to the substrate is capable of aligning the magnetically orientable material into an alignment.

19. The re-addressable label of claim 18 wherein the receptacle is a United State Postal Service sorting tray.

20. A method for addressing a bistable film comprising:
providing a substrate having a plurality of microcapsules disposed in the substrate, each of the microcapsules comprising a liquid and a magnetically orientable material suspended in the liquid; and
applying a magnetic field to the film to align the magnetically orientable material into an alignment.

21. The method of claim 20 wherein a second application of a magnetic field alters the alignment of the magnetically orientable material.

22. The method of claim 20 wherein the magnetic field is applied by a stylus.

23. A magnetically addressable film comprising:
a substrate; and
a plurality of microcapsules disposed in the substrate, each of the microcapsules comprising a liquid and a magnetophoretic material suspended in the liquid;
wherein application of a magnetic field is capable of dragging the magnetophoretic material into a congregation near a side portion of at least some of the microcapsules.
